(19) United States
(12) Patent Application Publication
(10) Pub. No.: US 2026/0348622 A1
(43) Pub. Date: Nov. 5, 2026

(54) SOLID FLUIDIZED PARTICLES RECEIVER WITH DISTRIBUTED CHANNEL NETWORKS

(71) Applicant: US Department of Energy, Washington, DC (US)

(72) Inventor: Julian Osorio, Arvada, CO (US)

(21) Appl. No.: 19/738,796

(22) Filed: Jul. 13, 2026

Related U.S. Application Data
(63) Continuation-in-part of application No. 18/889,922, filed on Sep. 19, 2024.

(51) Int. Cl. F24S 20/25; F24S 23/70; F24S 80/20

(52) U.S. Cl. CPC F24S 20/25; F24S 23/70; F24S 80/20

(57) ABSTRACT

Embodiments relate to a concentrating solar power system that transforms solar radiation into thermal energy and electricity. The concentrating solar power system includes a heliostat field and a central solid fluidized-particle solar receiver communicating with the heliostat field, the solid fluidized-particle solar receiver enabling simultaneous direct and indirect solar radiation absorption. The central solid fluidized-particle solar receiver includes a glass envelope; an elongated absorber plate in the glass envelope; a plurality of pipes in the glass envelope and connected to at least a first side of the absorber plate; a channel distribution network positioned between the absorber plate and the glass envelope and spaced from the glass envelope forming an airgap and in fluid communication with at least the pipes and an opposing second side of the absorber plate; and a fluidized particle lifting mechanism in the glass envelope and in fluid communication with at least the pipes.

### CROSS_REFERENCE TO RELATED APPLICATION

This application is a Continuation-in-Part of U.S. Patent Application No. 18/889,922, filed on Sep. 19, 2024, entitled “Solid Fluidized Particles Receiver with Distributed Networks,” the entirety of which is incorporated herein by reference.

### STATEMENT OF GOVERNMENT INTEREST

The United States Government has rights in this invention pursuant to a contract between the U.S. Department of Energy and the Alliance for Energy Innovation LLC (formerly Alliance for Sustainable Energy, LLC.) for the operation of the National Laboratory of the Rockies (formerly National Renewable Energy Laboratory).

### BACKGROUND OF THE INVENTION

Solar energy is one of the fastest-growing and most affordable source of new electricity in America. DOE’s Solar Energy Technologies Office (SETO) funds research and development across the solar energy spectrum to drive innovation, lower costs, and support the transition to a decarbonized power sector by 2035 and a decarbonized economy by 2050.

Concentrating solar power (CSP) systems transform solar radiation into thermal energy and ultimately electricity. The most common type of CSP systems consist of a heliostat field including several heliostats/reflectors (such as parabolic troughs, linear Fresnels, and Stirling dishes) and a central receiver system (CRS). FIG. 1 depicts a schematic diagram of a known CSP system 10 including a receiver 12 that transforms solar radiation into thermal energy and electricity. FIG. 1 illustrates that system 10 includes a plurality of heliostats 14 that receive solar radiation 16 and reflect it towards the receiver 12, forming reflected solar radiation 18. The receiver 12 is shown in fluid communication with storage unit/heat exchanger 20 via one or more conduits 22.

Currently, there are several different types of receivers either used in CSP systems, or are proposed for use, including molten salt solar receivers, solid particle receivers, falling particle receivers, and the like. Molten salt receivers are considered state-of-the-art. However, molten salt receivers are expensive and suffer from corrosion during high-temperature operations.

Solid particle receivers broadly fall into two categories: direct receivers, where particles directly absorb the solar radiation (including free-falling particles, obstructed flow, rotating kiln, fluidized receivers and the like), and indirect receivers (including heat exchanger (HEX), fluidized indirect receivers and the like). Such solid particle receivers have a number of limitations including the short residence time of the particles, the induction of natural convection in the front or back side of the falling particles resulting in heat loss, and uneven flow of the particles leading to uneven heating of the particles, affecting the system efficiency.

Several falling particle receivers have been constructed at Sandia National Laboratory in the United States and SCIRO in Australia. The efficiency of these receivers is between 70% and 83.5% due to significant thermal losses. Other limitations include uneven particle heating, particle loss, and heat losses through the aperture. Addressing current limitations of current particle receivers, while increasing their efficiency, is fundamental to progress towards the SETO DOE targets of cost reduction for CSP technologies to 5¢/kWh by 2030.

A need exists in the art for enabling simultaneous direct and indirect solar radiation absorption using solid fluidized-particle solar receivers, improving receiver efficiency by enhancing the absorption of solar radiation and increasing the residence time while reducing heat losses.

### SUMMARY OF THE INVENTION

One or more embodiments relate to a central solid fluidized-particle solar receiver that enables simultaneous direct and indirect solar radiation absorption. The central solid fluidized-particle solar receiver includes a glass envelope; an elongated absorber plate positioned in the glass envelope; a plurality of pipes positioned in the glass envelope and connected to at least a first side of the absorber plate; a channel distribution network positioned between the absorber plate and the glass envelope and spaced from the glass envelope forming an airgap and in fluid communication with at least the pipes and an opposing second side of the absorber plate; and a fluidized particle lifting mechanism positioned in the glass envelope and in fluid communication with at least the pipes.

Yet another embodiment relates to a concentrating solar power system that transforms solar radiation into thermal energy and electricity, wherein the concentrating solar power system includes a heliostat field and a central solid fluidized-particle solar receiver in communication with the heliostat field, the solid fluidized-particle solar receiver enabling simultaneous direct and indirect solar radiation absorption. The central solid fluidized-particle solar receiver includes a glass envelope; an elongated absorber plate positioned in the glass envelope; a plurality of pipes positioned in the glass envelope and connected to at least a first side of the absorber plate; a channel distribution network positioned between the absorber plate and the glass envelope and spaced from the glass envelope forming an airgap and in fluid communication with at least the pipes and an opposing second side of the absorber plate; and a fluidized particle lifting mechanism positioned in the glass envelope and in fluid communication with at least the pipes.

Embodiments include heliostats that include parabolic troughs, linear Fresnels, Stirling dishes, and combinations thereof. One or more embodiments include the pipes welded to the absorber plate, where one or more pipes may be highly conductive and are oriented vertically. Additional embodiments include the channel distribution network, which includes a plurality of channels, where one or more embodiments include the channels forming a plurality of hexagonal shapes in the channel distribution network. At least a portion of the plurality of channels are covered with a high absorptivity coating. Further embodiments may include the central solid fluidized-particle solar receiver defining a longitudinal axis, and further wherein the elongated absorber plate runs along the longitudinal axis, wherein in one embodiment the absorber plate has a cylindrical shape.

One or more embodiments relates to a solid fluidized-particle solar receiver enabling direct and indirect solar radiation absorption. In at least one embodiment, the solid fluidized-particle solar receiver includes an absorber plate, at least one pipe, a channel distribution network, a fluidized particle lifting mechanism, and a glass envelope. In at least one embodiment, the absorber plate has a first and opposing second side, where the at least one pipe (a vertically oriented high-conductivity pipe, for example) is connected (welded) to the first side. The channel distribution network is in fluid communication with at least the at least one pipe and the opposing second of the absorber plate. The fluidized particle lifting mechanism is in fluid communication with at least the at least one pipe.

In one or more embodiments, at least a portion of the channel distribution channel is positioned between the absorber plate and the glass envelope and spaced from the glass envelope forming an airgap. Embodiments are contemplated in which the channel distribution network includes a plurality of channels such that the plurality of channels form a plurality of hexagonal shapes of the channel distribution network. Yet other embodiments include hexagonal shapes wherein a plurality of channels and/or at least a portion of the plurality of channels are covered with a high absorptivity coating.

Yet another embodiment relates to a concentrating solar power system that transforms solar radiation into thermal energy and electricity, the concentrating solar power system a heliostat field comprising a number of heliostats (including parabolic troughs, linear Fresnels, Stirling dishes and the like); and a central solid fluidized-particle solar receiver in communication with the heliostats, where the solid fluidized-particle solar receiver enables direct and indirect solar radiation absorption. In this embodiment, the solid fluidized-particle solar receiver includes a glass envelope, an absorber plate positioned in the glass envelope, a plurality of pipes, a channel distribution network, and a fluidized particle lifting mechanism.

Yet another embodiment includes a method of transforming solar radiation into thermal energy and electricity using direct and indirect solar radiation absorption. The method includes receiving the solar radiation at a solid fluidized-particle solar receiver, forming received solar radiation; pumping solid fluidized-particles to a top of the solid fluidized-particle solar receiver through a series of pipes; preheating the solid fluidized particles in at least a portion of the pipes using received solar radiation, forming preheated solid fluidized particles; distributing the preheated solid fluidized particles in a channel distribution network; and absorbing the received solar radiation by conduction in the channel distribution network.

### BRIEF DESCRIPTION OF DRAWINGS

The invention together with the above and other objects and advantages will be best understood from the following detailed description of the preferred embodiment of the invention shown in the accompanying drawings, wherein:

FIG. 1 depicts a schematic diagram of a prior art concentrating solar power system including a receiver that transforms solar radiation into thermal energy and electricity;

FIG. 2 depicts a schematic diagram of a concentrating solar power system including a solid fluidized particle solar receiver that transforms solar radiation into thermal energy and electricity in accordance with one embodiment;

FIG. 3A depicts a detailed view of the upper portion of the solid fluidized receiver of FIG. 2 according to an embodiment of the invention;

FIG. 3B depicts a detailed partial view of the internal pipes of FIG. 3A taken along line 3B of FIG. 3A, according to an embodiment of the invention;

FIG. 3C depicts a detailed partial view of the channel distribution network of FIG. 3A taken along line 3C of FIG. 3A, according to an embodiment of the invention;

FIG. 4A depicts a detailed view of the lower portion of the solid fluidized receiver of FIG. 2 according to an embodiment of the invention;

FIG. 4B depicts a detailed partial view of the internal pipes of FIG. 4A taken along line 4B of FIG. 4A, according to an embodiment of the invention; and

FIG. 5 depicts a flow chart illustrating one embodiment of a method of transforming solar radiation into thermal energy using direct and indirect solar radiation absorption simultaneously according to an embodiment of the invention.

### DETAILED DESCRIPTION OF THE INVENTION

The foregoing summary, as well as the following detailed description of certain embodiments of the present invention, will be better understood when read in conjunction with the appended drawings.

The following detailed description should be read with reference to the drawings in which similar elements in different drawings are numbered the same. The drawings, which are not necessarily to scale, depict illustrative embodiments and are not intended to limit the scope of the invention.

One or more embodiments relate to a fluidized particle receiver with an optimized channel distribution network, particle preheating, and flow control which addresses the limitations of current state-of-the-art fall particle receivers and other particle receiver concepts by (1) increasing particle residence time with low-pressure losses, (2) particle preheating during lifting, (3) low convection and re-radiation heat losses, and (4) particle flow control capability. In one or more embodiments the residence time could be increased by more than 100% and thermal losses can be reduced by more than 30% using a glass envelope, leading to an improvement in the receiver efficiency between 4% and 8% when compared with the efficiency of known falling particle receivers. In addition, embodiments enable the flow control of the fluidized particles, permitting the receiver’s operation optimization based on solar radiation availability and load demand requirements. Contrary to current particle cavity receivers, one or more embodiments integrate a glass envelope on the receiver’s perimeter, allowing heat loss reduction and accommodation of heliostats over the entire range of azimuthal angles.

Embodiments use solid particles or fluidized particles as a heat transfer and storage medium and a channel distribution network. Solar radiation absorption increases as the fluidized particles absorb energy by conduction/convection during travel up to the top of the receiver and subsequently directly and indirectly absorb energy as they move through the channel distribution network. Embodiments also enable flow control of the fluidized particles, permitting the receiver’s operation optimization based on solar radiation availability and load demand requirements. Embodiments include a glass envelope on the receiver’s perimeter, reducing heat loss while accommodating heliostats over the entire range of azimuthal angles. Compared with molten salt receivers, particles allow higher operation temperatures, do not require a minimum operation temperature, and normally do not induce corrosion. It is anticipated that the particle residence time will increase by at least 50% with an increase in efficiency between 4% and 8%.

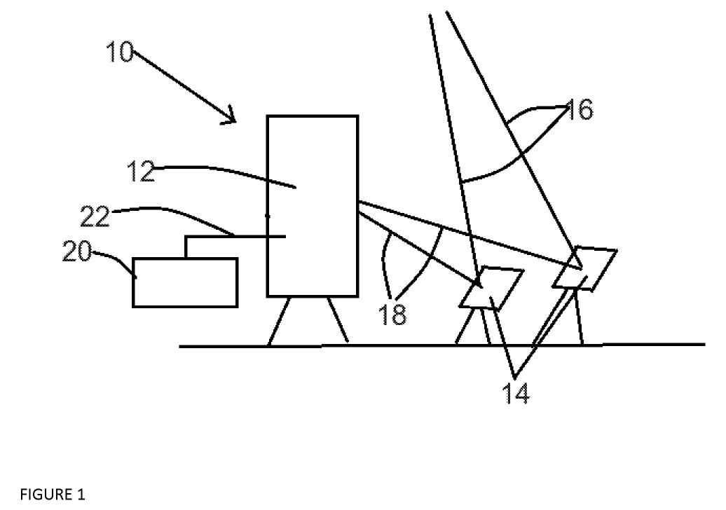

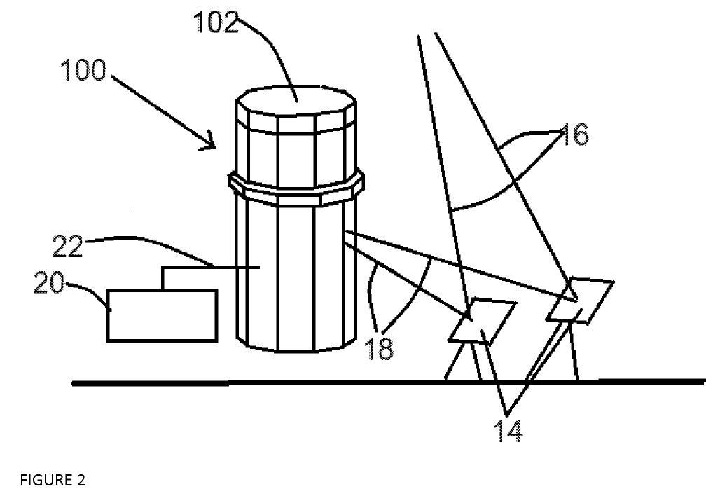

FIG. 2 depicts a schematic diagram of a concentrating solar power system generally designated 100 including a solid fluidized particle solar receiver 102 that transforms solar radiation into thermal energy and electricity in accordance with one embodiment. Similar to system 10 shown in FIG. 1, system 100 includes a plurality of heliostats 14 that receive solar radiation 16 and reflect it towards the receiver 102, forming reflected solar radiation 18. The receiver 102 is shown in fluid communication with storage unit/heat exchanger 20 via one or more conduits 22. It is contemplated that in at least one embodiment, the heliostats 14 may be selected from the group consisting of parabolic troughs, linear Fresnels, Stirling dishes, and the like. It should be appreciated that system 100 may include one or more solid fluidized particle solar receivers 102 or a plurality of solar receivers including one or more solid fluidized particle solar receivers 102 and one or more non-solid fluidized particle solar receivers.

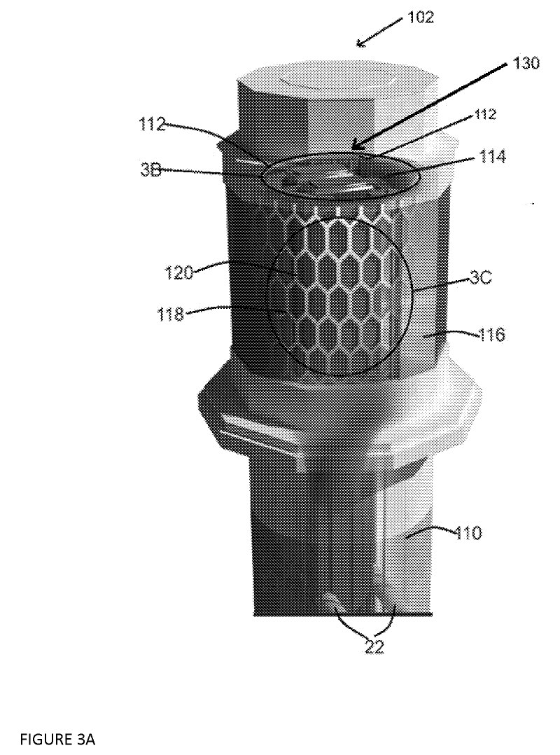

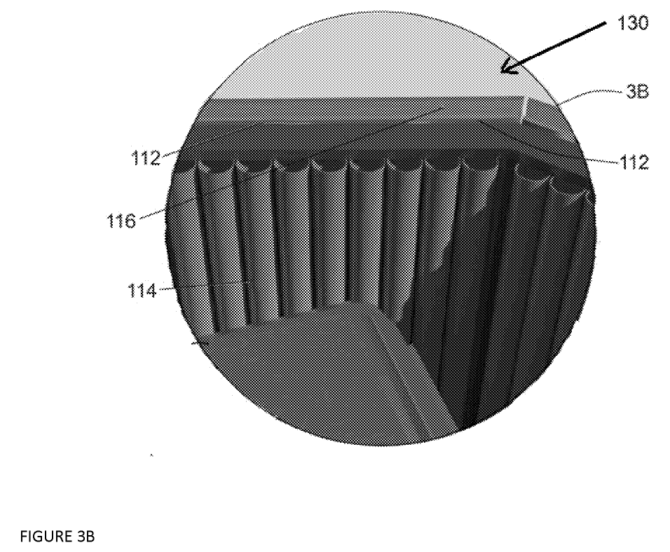

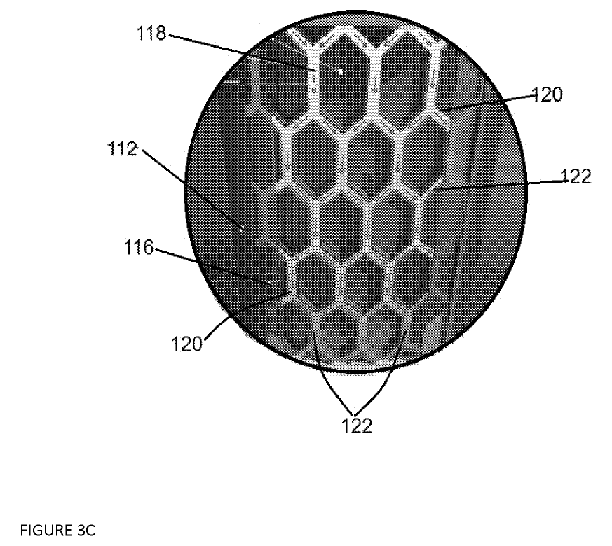

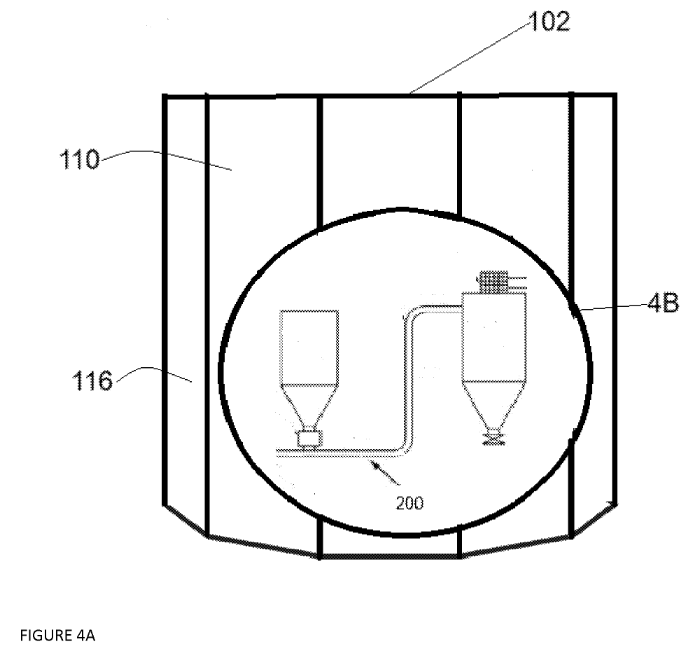

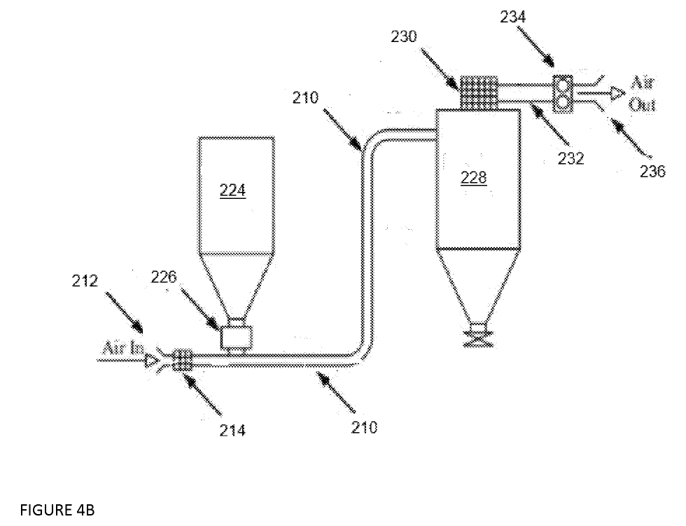

FIGS. 3A-3C depict detailed views of the solid fluidized receiver 102 and conduits 22 of FIG. 2 that transform solar radiation into thermal energy and electricity according to an embodiment of the invention. Specifically, FIG. 3A depicts a detailed view of the upper portion 130 of the solid fluidized receiver 102 including housing 110, a glass envelope 116, one or more absorber plates 112 positioned in the glass envelope 116; one or more pipes 114 positioned in an enclosure created by the glass envelope 116 but not in contact therewith and connected to at least one or more absorber plates 112 (in one embodiment to an external or front surface of absorber plate 112 such that it is positioned between the absorber plate 112 and the glass envelope 116). A channel distribution network 118 is shown positioned in the enclosure created by the glass envelope 116 but not in contact therewith and in fluid communication with at least the pipes 114; and a fluidized particle lifting mechanism 200 (best viewed in FIGS. 4A-4B) positioned in the glass envelope 116 and in fluid communication with at least the pipes 114. In one embodiment, absorber plate 112 has a first and second opposing side, where at least one pipe 114 is connected (welded for example) to the first side, and the channel distribution network is connected to the opposing second side.

In one or more embodiments, the glass envelope 116 is an external layer, which is almost transparent to solar radiation, while acting as an insulator to the energy re-radiation (once the energy reflects from the absorber plate 112, channels 120, and fluidized particles). It should be appreciated that the glass envelope 116 not only helps to contain the particles in the receiver 102 as they move down through the channels 120 but also helps to reduce convective heat losses.

FIG. 3B depicts a detailed partial view of the internal pipes 114 of FIG. 3A taken along line 3B of FIG. 3A, according to an embodiment of the invention. As discussed previously, receiver 102 includes one or more absorber plates 112 positioned in the glass envelope 116 and one or more pipes 114 positioned in the glass envelope 116 and connected to at least one or more of the absorber plates 112. In one embodiment at least one or more of the pipes 114 are welded to at least one absorber plate 112, although other means for connecting the pipes 114 to the absorber plate 112 is contemplated. Further, it is contemplated that one or more of the pipes 114 are high-conductivity and/or are oriented vertically with respect to the vertical orientation of the receiver 102.

FIG. 3C depicts a detailed partial view of the channel distribution network 118 of FIG. 3A taken along line 3C of FIG. 3A, according to an embodiment of the invention. FIG. 3C illustrates that the channel distribution network 118 is positioned in the glass envelope or cover 116 and in fluid communication with at least the pipes 114. As shown, the channel distribution network 118 includes a plurality of channels 120. In one embodiment, the plurality of channels 120 form a plurality of hexagonal shapes 122 in the channel distribution network 118, although other shapes are contemplated. Embodiments are contemplated wherein at least a portion of the plurality of channels 120 are covered with a high absorptivity coating and/or spaced from the glass envelope 116 forming an airgap.

One advantage of an embodiment of the solid fluidized receiver 102 is that it enables simultaneous absorption of direct and indirect solar radiation. That is, direct absorption when the solar radiation (after being reflected in the heliostat field) is absorbed by the fluidized particles, and indirect absorption when the solar radiation reaches the absorber plate 112 and distribution channels 118 and then is transferred by conduction to the fluidized particles. FIG. 3C further illustrates a glass cover or envelope 116 and an absorber plate 112, each having a high-absorptivity coating or paint applied to an external surface, for example. In the illustrated embodiment, solid fluidized receiver 102 defines a longitudinal axis, and an elongated absorber plate 112 is cylindrical, with an upper portion 130 that runs along the longitudinal axis of receiver 102. While a cylindrical shape is shown, any suitable shape is contemplated.

FIG. 4A depicts a detailed view of the lower portion of the solid fluidized receiver 102 of FIGS. 2 and 3A according to an embodiment of the invention, while FIG. 4B depicts a detailed partial view of the fluidized particle lifting mechanism generally designated 200 positioned in the housing 110 and glass envelope 116 and in fluid communication with at least one of the pipes 114.

Referring to FIG. 4B the embodiment of the fluidized particle lifting mechanism generally designated 200 includes conduit 210 in fluid communication with inlet 212 having inlet filter 214. As illustrated, feeder bin 224 is shown communicating with feeder 226 which is in fluid communication with conduit 210. Conduit 210 is further shown in fluid communication with receiving bin 228 having filter 230. Filter 230 is shown in communication with blower 234 and outlet 236 via conduit 232.

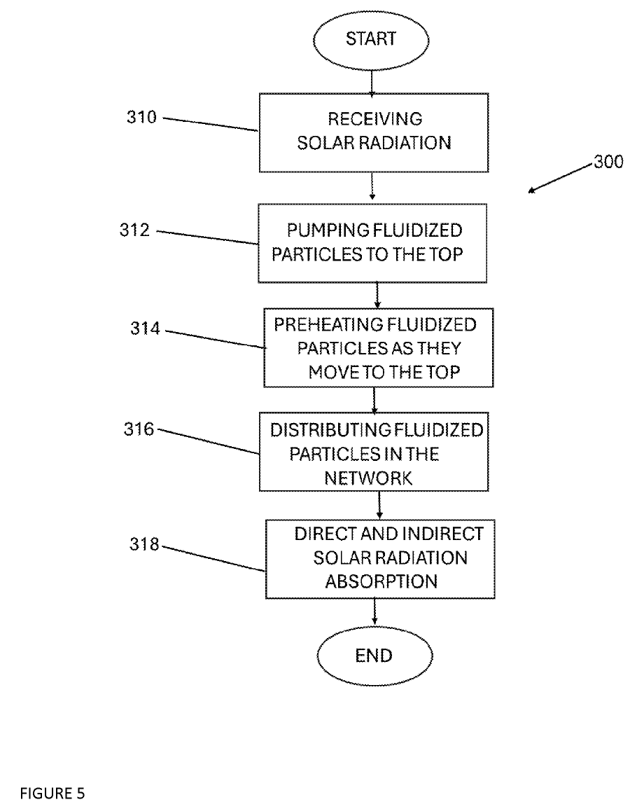

FIG. 5 depicts a flow chart, generally designated 300, illustrating one embodiment of a method of transforming solar radiation into thermal energy using direct and indirect solar radiation absorption simultaneously, according to an embodiment of the invention. In one embodiment, method 300 includes receiving the solar radiation at a solid fluidized-particle solar receiver, forming received solar radiation, block 310. Method 300 further includes pumping solid fluidized particles to a top of the solid fluidized-particle solar receiver 102 through a series of pipes 114, block 312 and preheating the solid fluidized particles in a least a portion of the pipes 114 using indirectly the received solar radiation, forming preheated solid fluidized particles, block 314. As shown, method 300 includes distributing the preheated solid fluidized particles in the channel distribution network 118, block 316 and absorbing the received solar radiation, block 318.

One or more embodiments of method 300 includes solar radiation absorbed by the preheated solid fluidized particles enabling direct solar radiation. Additionally, method 300 may include the received solar radiation reaching an absorber plate 112 and/or the channel distribution network 118 and being transferred by conduction to the preheated solid fluidized particles, enabling indirect solar radiation. Additional embodiments include reducing convective heat loss using the glass envelope.

Having described the basic concept of the embodiments, it will be apparent to those skilled in the art that the foregoing detailed disclosure is intended to be presented by way of example. Accordingly, these terms should be interpreted as indicating that insubstantial or inconsequential modifications or alterations and various improvements of the subject matter described and claimed are considered to be within the scope of the spirited embodiments as recited in the appended claims. Additionally, the recited order of the elements or sequences, or the use of numbers, letters or other designations therefor, is not intended to limit the claimed processes to any order except as may be specified. All ranges disclosed herein also encompass any and all possible sub-ranges and combinations of sub-ranges thereof. Any listed range is easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as up to, at least, greater than, less than, and the like refer to ranges which are subsequently broken down into sub-ranges as discussed above. As utilized herein, the terms “about,” “substantially,” and other similar terms are intended to have a broad meaning in conjunction with the common and accepted usage by those having ordinary skill in the art to which the subject matter of this disclosure pertains. As utilized herein, the term “approximately equal to” shall carry the meaning of being within 15, 10, 5, 4, 3, 2, or 1 percent of the subject measurement, item, unit, or concentration, with preference given to the percent variance. It should be understood by those of skill in the art who review this disclosure that these terms are intended to allow a description of certain features described and claimed without restricting the scope of these features to the exact numerical ranges provided. Accordingly, the embodiments are limited only by the following claims and equivalents thereto. All publications and patent documents cited in this application are incorporated by reference in their entirety for all purposes to the same extent as if each individual publication or patent document were so individually denoted.

All numeric values are herein assumed to be modified by the term “about”, whether or not explicitly indicated. The term “about” generally refers to a range of numbers that one of skill in the art would consider equivalent to the recited value (e.g., having the same function or result). In many instances, the terms “about” may include numbers that are rounded to the nearest significant figure.

The recitation of numerical ranges by endpoints includes all numbers within that range (e.g. 1 to 5 includes 1, 1.5, 2, 2.75, 3, 3.80, 4, and 5).

One skilled in the art will also readily recognize that where members are grouped together in a common manner, such as in a Markush group, the present invention encompasses not only the entire group listed as a whole, but each member of the group individually and all possible subgroups of the main group. Accordingly, for all purposes, the present invention encompasses not only the main group, but also the main group absent one or more of the group members. The present invention also envisages the explicit exclusion of one or more of any of the group members in the claimed invention.

1. A concentrating solar power system that transforms solar radiation into thermal energy and electricity, the concentrating solar power system comprising:
a heliostat field; and
a central solid fluidized-particle solar receiver in communication with the heliostat field, the solid fluidized-particle solar receiver enabling simultaneous direct and indirect solar radiation absorption and comprising:
a glass envelope;
an elongated absorber plate positioned in the glass envelope;
a plurality of pipes positioned in the glass envelope and connected to at least a first side of the absorber plate;
a channel distribution network positioned between the absorber plate and the glass envelope and spaced from the glass envelope forming an airgap and in fluid communication with at least the pipes and an opposing second side of the absorber plate; and
a fluidized particle lifting mechanism positioned in the glass envelope and in fluid communication with at least the pipes.

2. The concentrating solar power system of claim 1, wherein the heliostat field comprises at least one heliostat.

3. The concentrating solar power system of claim 1, wherein the heliostat field comprises a plurality of heliostats.

4. The concentrating solar power system of claim 2, wherein the at least one heliostat includes parabolic troughs, linear Fresnels, Stirling dishes, and combinations thereof.

5. The concentrating solar power system of claim 1, wherein the pipes are welded to the absorber plate.

6. The concentrating solar power system of claim 1, wherein the pipes are highly-conductivity.

7. The concentrating solar power system of claim 1, wherein the pipes are oriented vertically.

8. The concentrating solar power system of claim 1, wherein the channel distribution network includes a plurality of channels.

9. The concentrating solar power system of claim 8, wherein the plurality of channels form a plurality of hexagonal shapes in the channel distribution network.

10. The concentrating solar power system of claim 8, wherein at least a portion of the plurality of channels are covered with a high absorptivity coating.

11. The concentrating solar power system of claim 1, wherein the central solid fluidized-particle solar receiver defines a longitudinal axis, and further wherein the elongated absorber plate runs along the longitudinal axis.

12. The concentrating solar power receiver of claim 11, wherein the absorber plate has a cylindrical shape.

13. A method of transforming solar radiation into thermal energy and electricity using direct and indirect solar radiation absorption simultaneously, the method comprising:
receiving the solar radiation at a solid fluidized-particle solar receiver, forming received solar radiation;
pumping solid fluidized-particles to a top of the solid fluidized-particle solar receiver through a series of pipes;
preheating the solid fluidized particles in a least a portion of the pipes using received solar radiation, forming preheated solid fluidized particles;
distributing the preheated solid fluidized particles in a channel distribution network; and
absorbing the received solar radiation.

14. The method of claim 13, wherein absorbing the received solar radiation includes solar radiation absorbed by the preheated solid fluidized particles enabling direct solar radiation.

15. The method of claim 13, wherein absorbing the received solar radiation includes the received solar radiation reaching an absorber plate and the channel distribution network and is transferred by conduction to the preheated solid fluidized particles, enabling indirect solar radiation.

16. The method of claim 13, further comprising reducing convective heat loss using a glass envelope.
